(19) United States
(12) Patent Application Publication
(10) Pub. No.: US 2009/0220075 A1
(43) Pub. Date: Sep. 3, 2009

(54) MULTIFACTOR AUTHENTICATION SYSTEM AND METHODOLOGY

(75) Inventors: Dhananjay Singh Sidhu, Madhya Pradesh (IN); Tanvi Rustagi, Haryana (IN)

Correspondence Address: FORTKORT & HOUSTON P.C., 9442 N. CAPITAL OF TEXAS HIGHWAY, ARBORETUM PLAZA ONE, SUITE 500, AUSTIN, TX, 78759, US

(73) Assignee: Akros Techlabs, LLC

(21) Appl. No.: 12/395,615

(22) Filed: Feb. 27, 2009

Related U.S. Application Data
(60) Provisional application No. 61/032,422, filed on Feb. 28, 2008.

(51) Int. Cl. G06F 21/00; H04L 9/00

(52) U.S. Cl. 380/45; 726/18; 726/20

(57) ABSTRACT

A system is provided for authenticating a user who is accessing a secure network from a client device. The system comprises a software program resident on the client device, wherein said program is disposed in a tangible medium and contains suitable instructions for generating a session-specific, time-independent password on demand.

### CROSS-REFERENCE TO RELATED APPLICATIONS

The present application claims priority to U.S. Provisional Patent Application Ser. No. 61/032,422, entitled “UNIVERSAL PLATFORM FOR SECURED LOGIN THROUGH LOGIN ID AND PASSWORD (FOR INTERNET BANKING, STOCK MARKET TRANSACTIONS, SECURED EMAIL SYSTEMS AND OTHER RELATED APPLICATIONS THAT REQUIRE LOGIN ID AND PASSWORD) AND TRANSACTIONS THROUGH DEBIT CARDS AND CREDIT CARDS (I.E. THROUGH SWAP MACHINE, ATM MACHINES AND INTERNET BASED E-SHOPPING) USING EACH-TIME RANDOM GENERATION OF ADDITIONAL AUTHENTICITY PASSWORD (AAP) ON MOBILE PHONES, PDAS AND SIMILAR PERSONAL DEVICES”, FILED ON Feb. 28, 2008 and incorporated herein by reference in its entirety.

### FIELD OF THE DISCLOSURE

The present disclosure relates generally to systems and methods for authenticating a user in an electronic transaction, and more specifically to systems and methods for the local generation of Additional Authenticity Passwords (AAPs) for use in authenticating a user in an electronic transaction.

### BACKGROUND OF THE DISCLOSURE

Various systems and methods are currently known to the art for achieving security in electronic transactions. Typically, these systems and methods involve the use of user names, passwords and other user verification means to ensure that the user is who they say they are. However, many of the currently employed systems have well known security vulnerabilities associated with them.

For example, the use of usernames and Personal Identification Numbers (PINs) to gain access to online bank accounts or other secure sites is widespread in the industry. However, the security vulnerabilities associated with this type of system have been underscored in a number of recent high-profile cases, including one in which hackers gained access to a server that stored ATM PINs for transaction processing, stole an indeterminate number of PINs, and used the stolen PINs to process cash withdrawals at a chain of convenience stores. Other security breaches of this type have occurred as the result of phishing attacks or through the use of card skimming devices or fake PIN pads at ATM machines, gasoline pumps, payment counters, and other places where transactions involving ATM cards, credit cards or debit cards frequently occur.

Some attempts have been made in the art to deal with these security vulnerabilities. For example, in the past few years, various two-factor authentication systems have been implemented in the art to provide greater security for restricted sites. As the name implies, such systems require the use of two factors to authenticate a user. Typically, the two factors are something the user knows (such as a password), and either something the user has (such as a physical token or digital security certificate) or, in the case of biometric-based authentication systems such as fingerprint or retinal scanners, something the user is.

At present, one popular two-factor authentication system is a system based on the Short Message Service (SMS) protocol. Messages sent under this protocol may not exceed 160 alphanumeric characters, and cannot contain images. In a typical SMS implementation, a user connects to a server with their mobile phone or PDA using a username and password. A one-time access code is then delivered to the user via text messaging. This code, which is typically time-based and hence expires after a short amount of time, must be entered by the user in order to gain access to the network.

### BRIEF DESCRIPTION OF THE DRAWINGS

FIG. 1 is an illustration of an embodiment of a server side implementation of a method for generating AAPs in accordance with the teachings herein.

FIG. 2 is an illustration of an embodiment for a client side implementation of a method for generating AAPs in accordance with the teachings herein.

FIG. 3 is an illustration of a system for downloading and initializing AAP software in accordance with the teachings herein.

FIG. 4 is an illustration of a system for authenticating a user through the use of an AAP-generating device in accordance with the teachings herein.

FIG. 5 is an illustration of a system suitable for using an AAP-generating device of the type disclosed herein in conjunction with an ATM or card swiping device.

### SUMMARY OF THE DISCLOSURE

In one aspect, a device is provided which is equipped with a medium that is readable by the device and that has instructions stored therein for execution of a method comprising (a) obtaining a sequence of characters; (b) using the sequence to generate a key; (c) generating a set of random numbers; and (d) using the set of random numbers and the key to generate a time-independent password on demand.

In another aspect, a system is provided for authenticating a user who is accessing a secure network from a client device. The system comprises a software program resident on the client device, wherein said program is disposed in a tangible medium and contains suitable instructions for generating a session-specific, time-independent password on demand.

In a further aspect, a method is provided for authenticating a user of a client device on a secure site. The method comprises (a) downloading a software program from a server onto the client device, wherein the server assigns a unique character sequence to the software at the time of download; (b) using the character sequence to generate a key; (c) generating a set of random numbers; (d) using the set of random numbers and the key to generate a time-independent password; and (e) using the password to access the secure site.

In still another aspect, a method is provided for authenticating a user of a client device on a secure site. The method comprises (a) requiring the user to download a software program onto the client device, wherein the software program contains suitable instructions for generating a set of random numbers; (b) assigning a unique character sequence to the software, wherein the software further contains instructions for using the character sequence to generate a key, and using the set of random numbers and the key to generate a time-independent password; and (c) requiring input of the password to access the secure site.

### DETAILED DESCRIPTION

While SMS-based systems represent an improvement in security compared to systems that rely solely on a username and password, current SMS-based systems have their own shortcomings. For example, a typical SMS implementation requires a significant investment in overhead and infrastructure, due to the need for servers which can handle high volumes of communications. This may be appreciated by considering the large number of online transactions which occur each day in the banking industry alone (a major user of SMS-based systems), each of which requires the generation of multiple communications to properly authenticate the user. Indeed, this feature of current SMS-based implementations renders them susceptible to denial-of-service attacks, as reported by W. Enck, P. Traynor, P. McDaniel, and T. La Porta, “Exploiting Open Functionality in SMS Capable Cellular Networks”, CCS'05 (Nov. 7-11, 2005).

In addition to denial-of-service attacks, SMS implementations as they are currently known in the art are also highly prone to other types of network communication disruptions due to virus attacks, hardware failures, weather, solar flares, or legitimate high network traffic volumes. On the other hand, existing hardware solutions, such as those based on tokens, dongles or fabs, which might potentially be used (either as an

It has now been found that the above noted problems may be reduced or eliminated through the use of systems and methodologies which utilize the localized generation of passwords or keys through software which is resident on a computer or mobile communications device associated with a user. These passwords or keys, which are frequently referred to herein as Additional Authenticity Passwords (AAPs), are preferably time-independent (that is, not time based), one-time or session specific passwords, which are preferably used in conjunction with, and in addition to, a conventional username (or user ID) and password to gain access to a secure site, though in some applications (such as credit card verification), they may be used as the sole authentication means. The software which generates the AAP is preferably protected with a password or PIN so that, even if a malicious third party gains access to the user's username and password, and also gains access to the user's computer or mobile communications device itself, the third party will be unable to access the software as required to commence or complete a transaction on the secure site.

The systems and methodologies described herein offer many potential advantages over existing authentication systems known to the art, including the SMS-based authentication systems described above. Unlike SMS-implementations, systems may be made in accordance with the teachings herein which do not require access (through a TCP/IP pipe or otherwise) to a server for authentication of a user each time an electronic transaction is being initiated, and therefore do not require most of the infrastructure of existing authentication systems. Since server access is not required for authentication, these systems and methodologies are less vulnerable to denial-of-service attacks or other network disruptions of the type described above.

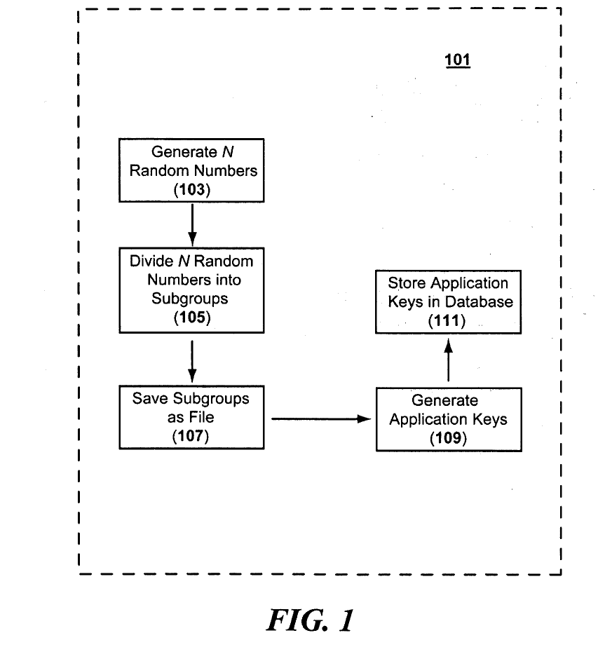

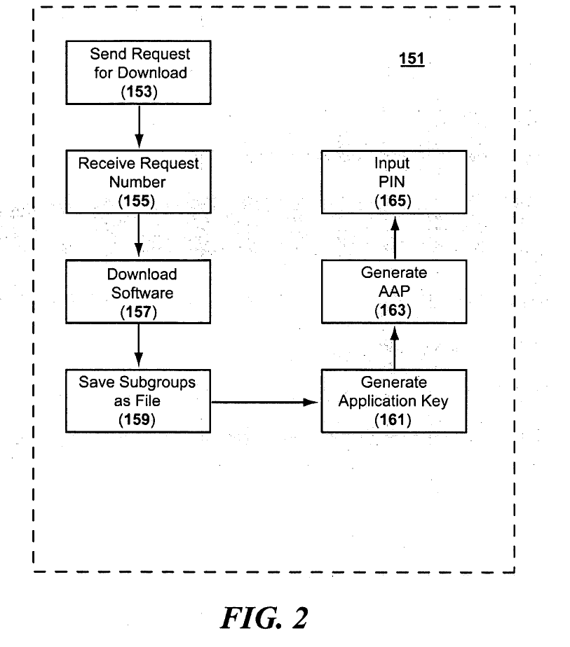

The systems and methodologies disclosed herein may be better understood with reference to FIGS. 1-2, which disclose a first particular, non-limiting embodiment of a methodology which may be utilized to implement the systems disclosed herein. In accordance with the methodologies illustrated therein, software components for generating AAPs are installed on both the server side and on the client side of the transaction. In a given installation, these software components may be essentially the same, or in the alternative, some or all of the software components installed on the server side may be different from the software components installed on the client side. For the sake of simplicity, however, these software components will simply be referred to collectively as the “software” in the remaining discussion herein, with no further distinction being made between them.

A first particular, non-limiting embodiment of the methodology (101) as implemented on the server side is depicted in FIG. 1. As seen therein, after installation of the software, the software application generates (103) N random numbers. The random number generation preferably excludes certain numbers, such as 00, 11, . . . , 99. The generated N random numbers are then divided (105) into subgroups. Preferably, the N random numbers are divided into N subgroups, each containing N members. All of these subgroups are saved (107) as a file on the application server. The process of generating the random numbers preferably occurs only once, at the time of installation of the application on the server. In subsequent use, and as explained in greater detail below, the software application then uses a 128-bit algorithm to generate a unique application key (109) for each user on the client side based on the request number assigned to that user. The application keys for all of the users of the software are stored (111) in the application server database.

A first particular, non-limiting embodiment of the methodology (151) as implemented on the client side is depicted in FIG. 2. As seen therein, the software for generating AAPs is downloaded (157) on a user's computer or mobile communications device (referred to collectively herein as the client device). The download of software onto the client device is preferably a one-time event, excepting such circumstances as loss of a password, the loss or replacement of the client device, or possibly in the case of software upgrades. The download may occur during account set-up, the user's first visit to a protected site, or at other such times.

In a preferred embodiment, in order to download the application, the user sends a request (153) to an application server which is tasked with handling downloads of the software, after which a unique request number assigned to the user is received (155). The application server may be the same as, or different from, the server which handles subsequent user authentications. This request number is then used to download (157) the software onto the client device, and is further utilized to generate an application key (161) as described below. In addition, one of the N subgroups of N random numbers generated on the server as described above (see step 103 of FIG. 1) is downloaded (159) from the server to the client device, preferably at the time of software installation on the client device.

Still referring to FIG. 2, during subsequent use, each time the user is required to be authenticated, the software application on the client device generates (163) a different encrypted, session-specific, time-independent AAP on the basis of the application key and the N random numbers. Notably, the encrypted AAPs are generated internally on the client device itself without the need to communicate to an external server, thus eliminating the communications traffic and infrastructure attendant to many current SMS implementations.

Moreover, each time user authentication is performed, the user is required to input a PIN (165) in order to access or use the AAP generating software. Preferably, this PIN is known only to the user, and is not written down anywhere. Consequently, even if the user's username and password is compromised by a malicious entity, and even if the malicious entity knows the user's username and password and gains control of the client device, the malicious entity will be unable to consummate any transactions on the user's account, because the malicious entity will not know the PIN required to access and use the software.

Upon successful download and activation of the software application on a client device associated with a user, the user is enabled to perform a variety of transactions that require authentication of the user. By way of example and illustration, a non-limiting listing of some of the transactions that may be enabled by the software is set forth in TABLE 1 below.

TABLE 1
Example Transaction Types

| Type A | Type B |
|---|---|
| Banking Transactions: Accessing bank | Debit Card and Credit Card Transactions: |
| accounts through the Internet and | Card transactions through swap machines, |
| performing various permissible | ATM machines and net based e-shopping |
| transactions | |
| Stock Market Transactions: Sale/purchase | |
| of securities and viewing account details | |
| (holdings, financial statements and all other | |
| permissible transactions and reports) | |
| Secure Data Systems: Accessing secure e- | |
| mail/data/IT systems (generally used in | |
| high sensitivity areas such as defense | |
| organizations and research centers) | |
| Medical Data: Access by healthcare | |
| personnel to patient medical records | |

The transactions set forth in TABLE 1 include Type A transactions which are initiated using a login ID, password and AAP. In some embodiments, a user may be requested to provide all three inputs at once or in succession, while in other embodiments, an initial login may be required using a user ID and password and, after successful confirmation of these inputs, the user may be prompted to enter an AAP. Type B transactions may also be implemented, which can be performed using AAPs alone.

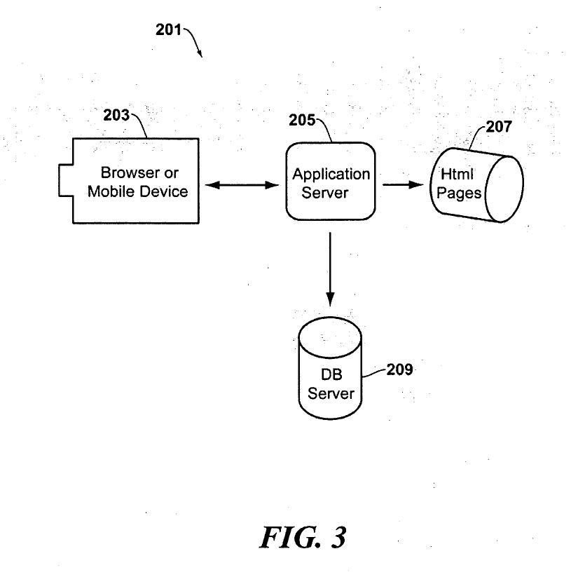

FIG. 3 illustrates one particular, non-limiting embodiment of a system in accordance with the teachings herein by which the software application may be downloaded and initialized as described above. In the system 201 depicted therein, a user on a client device 203 sends a request to an application server 205 to download the AAP application. The application server 205 will have various html pages 207 associated with it which facilitate the dialog between the user and the application server 205 involved with downloading and initializing the AAP software. The application server 205 will also have a database server 209 associated with it which stores the request number associated with the user and which further stores the encryption key. A set of random numbers (which was generated on application server 205 at the time the AAP software was installed) gets copied to the client device 203.

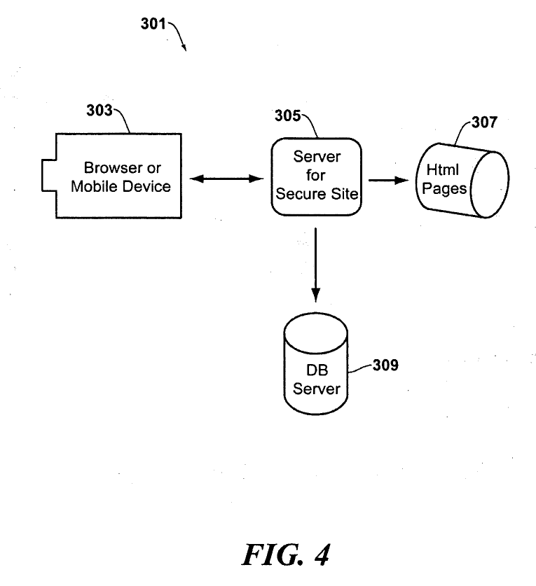

FIG. 4 illustrates a particular, non-limiting embodiment of a system by which a user is authenticated in accordance with the teachings herein. In the system 301 depicted therein, a user on a client device 303 logs onto a secure site on a server 305 using a username and password. The server 305 is preferably the same as (but in some embodiments may be different from) the application server 201 depicted in FIG. 3. The logon process is facilitated with the use of html pages 307 stored on the server 305 or an associated device. The AAP software installed on the client device 303 prompts the user to enter a PIN. If a valid PIN is entered by the user, the AAP software generates an encrypted N-digit AAP which is then entered by the user and transmitted to the server 305. The server 305 decrypts the encrypted AAP with the help of the application key which is stored in the database 309, and verifies the validity of the received AAP.

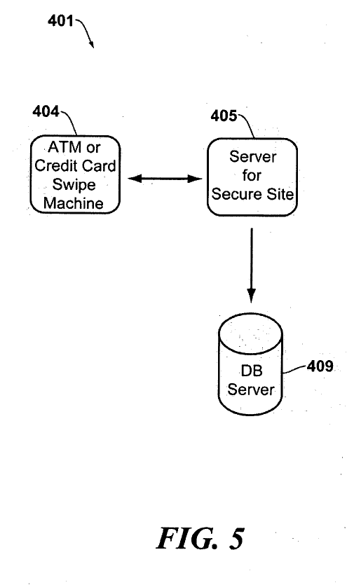

FIG. 5 illustrates a further particular, non-limiting embodiment of a system by which a user is authenticated in accordance with the teachings herein. In the system 401 depicted therein, a user on a client device performs a transaction by swiping a credit card on a third party credit card swap machine, or by swiping a debit card on a ATM machine 404. A server 405 verifies the credit card or ATM card after accepting the password. After verification of the credit card or ATM card, the server 405 prompts the user to enter a PIN. By using the AAP software installed on the client device 404, the user will generate an encrypted N-digit AAP which is then entered by the user manually on 404 and transmitted to the server 405. The server 405 decrypts the encrypted AAP with the help of the application key, which is stored in the database 409, and verifies the validity of the received AAP.

The systems and methodologies described above may be utilized in a wide variety of different applications and environments. These include, without limitation, their use in online banking or online financial transactions, credit/debit card transactions, online shopping, online payment systems, the use of ATM machines, access to secure online accounts, websites or email platforms, and access to secure databases (including, without limitation, databases containing patient or client data, such as those currently employed in the MediCare system, and access to databases containing criminal records, motor vehicle registrations, and driver's license information, such as those currently used in law enforcement).

Moreover, while these systems and methodologies have been specifically described with respect to their use in generating AAPs in electronic transactions, it will be appreciated that they may be more broadly utilized in any transaction where the local generation of random passwords is useful or desirable. For example, the systems and methodologies disclosed herein may be used to allow the generation of AAPs on client devices for additional authentication in gaining access to research centers, military bases, and other secure physical sites.

Various encryption algorithms may be used to encrypt the application key, the generated AAPs, or other data utilized in the systems and methodologies disclosed herein. Typically, the application key required for the generation of AAP will be encrypted on at least 3 levels, whereas AAP will be encrypted on at least 4 levels.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1. A device equipped with a medium which is readable by the device and which has instructions stored therein for execution of a method comprising:
obtaining a sequence of characters and a set of random numbers;
using the sequence to generate a key; and
using the set of random numbers and the key to generate a time-independent password on demand.

2. The device of claim 1, wherein the instructions are downloaded from a server onto the medium, and wherein the sequence of characters is obtained from the server.

3. The device of claim 2, wherein the password is a one-time password.

4. The device of claim 2, wherein the password is generated on the client device.

5. The device of claim 1, wherein the key is encrypted on at least three levels when it is generated, and wherein the password is encrypted on at least four levels when it is generated.

6. The device of claim 1, wherein the sequence is used in conjunction with a 128-bit algorithm to generate the key.

7. The device of claim 1, wherein each number in the set of random numbers is divided into N parts containing N numbers in each part.

8. The device of claim 1, wherein the password is used in conjunction with a user ID and a second password to gain access to a secure site.

9. The device of claim 1, wherein the password is a session-specific password which is generated in response to a request from a secure site that a user of the device is attempting to gain access to.

10. The device of claim 1, wherein said device is a mobile communications device.

11. The device of claim 1, wherein said device is a computer.

12. A system for authenticating a user who is accessing a secure network from a client device, comprising:
a software program resident on the client device, wherein said program is disposed in a tangible medium and contains suitable instructions for generating a session-specific, time-independent password on demand.

13. The system of claim 12, wherein said software program contains suitable instructions for generating a one-time password upon demand.

14. The system of claim 12, wherein said software program contains suitable instructions for generating session specific passwords upon demand.

15. The system of claim 12, wherein said software program generates passwords locally on the client device.

16. The system of claim 15, wherein the software is downloaded onto the client device from an application server, and wherein the application server assigns a unique request number to the user at the time of download.

17. The system of claim 16, wherein the software uses the request number to generate an application key.

18. The system of claim 17, wherein the application key is encrypted on at least three levels when it is generated.

19. The system of claim 16, wherein the software uses the request number and a 128-bit algorithm to generate an application key.

20. The system of claim 17, wherein the software uses the application key to generate passwords upon demand.

21. The system of claim 20, wherein the software generates a set of random numbers, and wherein the software uses the random numbers and the application key to generate passwords upon demand.

22. The system of claim 21, wherein each number in the set of random numbers is divided into N parts containing N numbers in each part.

23. The system of claim 21, wherein the set of random numbers are generated as encrypted numbers.

24. The system of claim 12, wherein the password is used in conjunction with a username and a separate password to gain access to the secure site.

25. The system of claim 12, wherein the device is a mobile communications device.

26. The system of claim 12, wherein the device is a computer.

27. A method for authenticating a user, comprising:
downloading a software program from a server onto a client device;
obtaining a request number from the server;
using the request number to generate an application key;
generating a set of random numbers; and
using the application key and the set of random numbers to generate a time-independent password upon demand.

28. The method of claim 27, wherein the client is a mobile communications device.

29. The method of claim 27, wherein the client is a computer.

30. A method for authenticating a user of a client device on a secure site, comprising:
downloading a software program from a server onto the client device, wherein the server assigns a unique character sequence to the software at the time of download;
using the character sequence to generate a key;
generating a set of random numbers;
using the set of random numbers and the key to generate a time-independent password; and
using the password to access the secure site.

31. The method of claim 30, wherein the password is a session specific password.

32. The method of claim 30, wherein the secure site requests the user to input a user name and second password.

33. The method of claim 30, wherein access to the software requires the user to access a personal identification number (PIN).

34. The method of claim 30, wherein the software requires the user to access a personal identification number (PIN) each time a session-specific password is generated.

35. The method of claim 30, wherein the client device is a mobile communications device.

36. The method of claim 30, wherein the client device is a computer.

37. A method for authenticating a user of a client device on a secure site, comprising:
requiring the user to download a software program onto the client device, wherein the software program contains suitable instructions for generating a set of random numbers;
assigning a unique character sequence to the software, wherein the software further contains instructions for using the character sequence to generate a key, and using the set of random numbers and the key to generate a time-independent password; and
requiring input of the password to access the secure site.

38. The method of claim 37, wherein the password is a session specific password.

39. The method of claim 37, wherein the client device is a mobile communications device.

40. The method of claim 37, wherein the client device is a computer.
